(19) United States
(12) Patent Application Publication
(10) Pub. No.: US 2003/0207686 A1
(43) Pub. Date: Nov. 6, 2003

(54) Method and apparatus for providing accounting updates in a packet data communication system

(76) Inventors: Shreesha Ramanna, Vernon Hills, IL (US); Dan Zhang, Vernon Hills, IL (US); Jay Jayapalan, Buffalo Grove, IL (US)

Correspondence Address: MOTOROLA, INC., 1303 EAST ALGONQUIN ROAD, IL01/3RD, SCHAUMBURG, IL, 60196

(21) Appl. No.: 10/427,494

(22) Filed: Apr. 30, 2003

Related U.S. Application Data
(60) Provisional application No. 60/376,774, filed on May 1, 2002.

(51) Int. Cl. H04Q 7/20

(52) U.S. Cl. 455/435.1; 455/436

(57) ABSTRACT

A packet data communication system that includes a base station subsystem (BSS) operably coupled to a packet control function (PCF) via an A8/A9 interface and a packet data service node (PDSN) operably coupled to the PCF via an A10/A11 interface provides accounting updates concerning data received and/or transmitted by the BSS. The BSS determines a quantity of data received by the BSS from, and/or transmitted by the BSS to, a mobile station and conveys a first set of information concerning the determined quantity of data to the PCF. In response to receiving the first set of information, the PCF conveys a second set of information concerning the determined quantity of data to the PDSN. In response to receiving the second set of information, the PDSN conveys a third set of information concerning the determined quantity of data to a billing service.

### REFERENCE(S) TO RELATED APPLICATION(S)

The present application claims priority from provisional application, Serial No. 60/376,774, entitled “METHOD AND APPARATUS FOR PROVIDING ACCOUNTING UPDATES IN A PACKET DATA COMMUNICATION SYSTEM,” filed May 1, 2002, which is commonly owned and incorporated herein by reference in its entirety.

### FIELD OF THE INVENTION

The present invention relates generally to cellular communication systems, and, in particular, to data transmission protocols in a packet data communication system.

### BACKGROUND OF THE INVENTION

The TIA/EIA (Telecommunications Industry Association/Electronic Industries Association) IS-2001, or IOS (3GPP2 Inter Operability Specification), standard provides a compatibility standard for cellular mobile telecommunications systems that operate as a cdma2000, 1XEV-DO or any other technology supported by an IS-2001 based Access Network. The standard ensures that a mobile station (MS) operating in a cdma2000 system can obtain communication services when operating in a cellular communication system or personal communication system (PCS) manufactured according to the standard. To ensure compatibility, radio system parameters and call processing procedures are specified by the standard, including call processing steps that are executed by an MS and a base station serving the MS in order to establish a call and digital control messages and analog signals that are exchanged between elements of an infrastructure that includes the base station.

FIG. 1 is a block diagram illustration of a typical cdma2000 communication system 100 of the prior art. Communication system 100 includes an MS 102 in communication with a base station subsystem (BSS) 106 via an air interface 104. Typically, data is transferred between MS 102 and BSS 106 over air interface 104 pursuant to a Radio Link Protocol (RLP). BSS 106 is coupled to a Packet Control Function (PCF) 110 via an A8/A9, or A_{quinter}, interface 108 that includes an A8 interface that provides a bearer path between the BSS and the PCF and an A9 signaling interface. PCF 110 is coupled to a Packet Data Service Node (PDSN) 114 via an A11/A11, or A_{quater}, interface 112 that includes an A10 interface that provides a bearer path between the PCF and the PDSN and an A11 signaling interface. BSS 106, PCF 110 and PDSN 114 are collectively referred to as a wireless infrastructure. PDSN 114 is, in turn, coupled to an Internet Service Provider (ISP) 116 that provides access for MS 102 to the Internet 118 and web servers 120 (one shown) coupled to the Internet.

In communication system 100, when MS 102 downloads data from a web server 120, the data is conveyed to MS 102 via ISP 116, PDSN 114, PCF 110, and BSS 106. The data is typically included in data packets that are formatted pursuant to the Internet Protocol (IP) standard. PDSN 114 monitors the number of bytes sent and/or received by the wireless infrastructure, and in particular by the PDSN, from ISP 116 and keeps a count of the number of sent and/or received bytes. PDSN then conveys a count of the number of received bytes to an Authentication, Authorization, and Accounting (AAA) server 122 associated with ISP 116 in an Accounting Request message. Billing service 124 then retrieves accounting records from AAA server 122 and bills a customer associated with MS 102 a fee based on the count of the number of bytes sent and/or received by PSDN 114.

One problem associated with the billing, or accounting, process provided by communication system 100 is that the byte count conveyed by PDSN 114 to AAA server 122 does not reflect any data packets dropped by the infrastructure after being received by PDSN 114 from ISP 116, nor does the process reflect any data packets lost in transit from BSS 106 to MS 102 due to poor conditions of air interface 104. Furthermore, when a handoff of MS 102 occurs from PCF 110 to another PCF (not shown), data packets may be discarded by PCF 110 that are not reflected in the billing of the customer associated with MS 102.

For example, when MS 102 is in a poor coverage area with respect to BSS 106, the poor coverage may result in high levels of Frame Erasure rates (FER). The high levels of FER in turn may cause data packets being transferred from ISP 116 to MS 102 to queue up in buffers residing in at BSS 106. The queuing up of data packets at BSS 106 may, in turn, cause data packets being transferred from ISP 116 to MS 102 to queue up in buffers residing in of PCF 110. When the buffers in BSS 106 and PCF 110 are full, additional data packets received by the BSS and PCF that are intended for MS 102 may get dropped. However, these dropped packets are counted by PDSN 114 as successful transfers and are reported by the PDSN to AAA server 122 as such. The dropped data packets may then have to be retransmitted by PDSN 114 or ISP 116 and the retransmitted data packets may also be counted by PDSN 114 as successful transfers and are reported by the PDSN to AAA server 122 as such. A result is that the customer associated with MS 102 is billed for each of the dropped data packets, producing a bill that fails to properly correspond to the number of data packets actually received by the MS.

By way of another example, MS 102 may be dormant while still engaged in an active session but for which no radio resources are assigned. Meanwhile PDSN 114 may be unaware that MS 102 is dormant and continue to push data to PCF 110. Once again, when the buffers in PCF 110 are full, additional data packets received by the PCF that are intended for MS 102 may get dropped, which dropped packets may be counted by PDSN 114 as successful transfers and reported by the PDSN to AAA server 122 as such. Again, a result is that the customer associated with MS 102 is billed for data that was never received by the MS.

Therefore, a need exists for a method and apparatus that provides a more accurate system of accounting for a quantity of data transferred to a mobile station such as MS 102.

### BRIEF DESCRIPTION OF THE DRAWINGS

FIG. 1 is a block diagram of a wireless communication system of the prior art.

FIG. 2 is a block diagram of a wireless communication system in accordance with an embodiment of the present invention.

FIG. 3 is a logic flow diagram of the steps executed by the communication system of FIG. 2 in providing an accounting providing to a billing system in accordance with an embodiment of the present invention.

FIG. 4 is a block diagram of a Usage Report data field of an A8/A9 Release or Update messages in accordance with an embodiment of the present invention.

FIG. 5 is a block diagram of a Normal Vendor/Organization Specific Extension (NSVE) of an A10/A11 Registration Request message in accordance with an embodiment of the present invention.

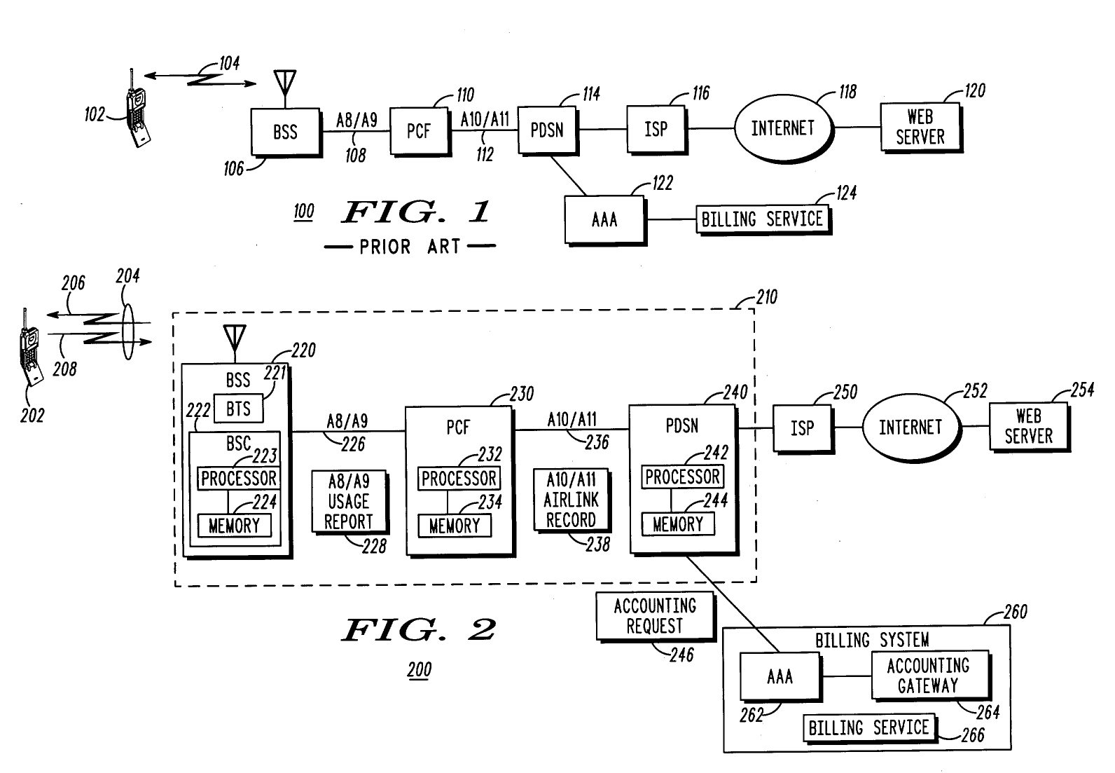

### DETAILED DESCRIPTION OF THE INVENTION

To address the need for a method and an apparatus provides a more accurate system of accounting for a quantity of data transferred to a mobile station, a packet data communication system that includes a base station subsystem (BSS) operably coupled to a packet control function (PCF) via an A8/A9 interface and a packet data service node (PDSN) operably coupled to the PCF via an A10/A11 interface provides accounting updates concerning data received and/or transmitted by the BSS. The BSS determines a quantity of data received by the BSS from, and/or transmitted by the BSS to, a mobile station and conveys a first set of information concerning the determined quantity of data to the PCF. In response to receiving the first set of information, the PCF conveys a second set of information concerning the determined quantity of data to the PDSN. In response to receiving the second set of information, the PDSN conveys a third set of information concerning the determined quantity of data to a billing service.

Generally, an embodiment of the present invention encompasses a method for providing accounting updates in a packet data communication system. The method includes steps of determining, by a base station subsystem (BSS), at least one of quantity of data received by the BSS from a mobile station and a quantity of data transmitted by the BSS to the mobile station and conveying, by the BSS, a first set of information concerning the determined quantity of data to a packet control function (PCF) via an A8/A9 interface. The method further includes steps of conveying, by the PCF and in response to receiving the first set of information, a second set of information concerning the determined quantity of data to a packet data service node (PDSN) via an A10/A11 interface and conveying, by the PDSN and in response to receiving the second set of information, a third set of information concerning the determined quantity of data to a billing service.

Another embodiment of the present invention encompasses an apparatus for providing an accounting update for a packet data communication system. The apparatus includes a base station controller (BSC) that determines at least one of quantity of data received by a base station subsystem (BSS) from a mobile station and a quantity of data transmitted by the BSS to the mobile station and assembles an A8/A9 Usage Report parameter comprising a first set of information concerning the determined quantity of data.

Still another embodiment of the present invention encompasses an apparatus for providing an accounting update for a packet data communication system. The apparatus includes a packet control function (PCF) that receives data concerning at least one of a quantity of data received by a base station subsystem from a mobile station and a quantity of data transmitted by the base station subsystem to a mobile station and, based on the sent and/or received data, assembles an A10/A11 Airlink Record comprising a information concerning the sent and/or received data.

Yet another embodiment of the present invention encompasses a machine-readable medium having stored thereon machine-executable instructions for assembling an A8/A9 message comprising at least one of a quantity of data received by a base station subsystem from a mobile station and a quantity of data transmitted by the base station subsystem to a mobile station.

Still another embodiment of the present invention encompasses a machine-readable medium having stored thereon machine-executable instructions for assembling an A10/A11 message comprising at least one of a quantity of data received by a base station subsystem from a mobile station and a quantity of data transmitted by the base station subsystem to a mobile station.

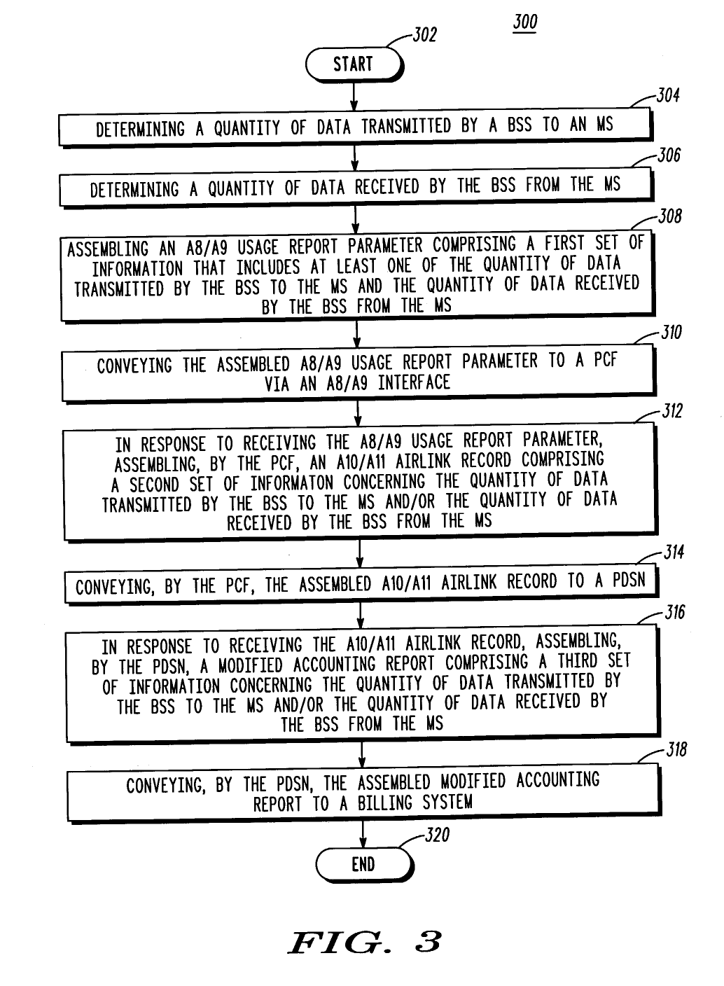

The present invention may be more fully described with reference to FIGS. 2-5. FIG. 2 is a block diagram of a wireless communication system 200 in accordance with an embodiment of the present invention. Communication system 200 includes at least one mobile station (MS) 202 and a base station subsystem (BSS) 220 that communicate via an air interface 204 that includes a forward link 206 and a reverse link 208. BSS 220 preferably includes at least one base transceiver station (BTS) 221 operably coupled to a base station controller (BSC) 222.

BSS 220, preferably BSC 222 of BSS 220, is operably coupled to a Packet Control Function (PCF) 230, which in turn is operably coupled to a Packet Data Service Node (PDSN) 240. BSS 220, PCF 230, and PDSN 240 are collectively referred to herein as a telecommunications infrastructure 210. Telecommunications infrastructure 210, preferably PDSN 240, is operably coupled to an external network comprising an ISP 250 in communication with the Internet 252 and, via the Internet, a web server 254. Each of BSC 222, PCF 230, and PDSN 240 includes a respective processor 223, 232, 242, such as one or more microprocessors, microcontrollers, digital signal processors (DSPs), combinations thereof or such other devices known to those having ordinary skill in the art, and one or more associated memory devices 224, 234, 244, such as random access memory (RAM), dynamic random access memory (DRAM), and/or read only memory (ROM) or equivalents thereof, that store data and programs that may be executed by the corresponding processor.

Communication system 200 comprises a wireless packet data communication system. In order for MS 202 to establish a packet data connection with an external network such as the network comprising ISP 250, the Internet 252, and web server 254, each of BSS 220, PCF 230, and PDSN 240 operates in accordance with well-known wireless telecommunications protocols. By operating in accordance with well-known protocols, a user of MS 202 can be assured that MS 202 will be able to communicate with infrastructure 210 and establish a packet data communication link with an external network via infrastructure 210. Preferably, communication system 200 operates in accordance with the 3GPP2 and TIA/EIA (Telecommunications Industry Association/Electronic Industries Association) IS-2001, or IOS (Inter Operability Specification), standard, which provides a compatibility standard for IS-2000, that is, cdma2000 or 1xEV-DO, systems, and infrastructure 210 comprises an IS-2001 access network. The standard specifies wireless telecommunications system operating protocols, including radio system parameters and call processing procedures. However, those who are of ordinary skill in the art realize that communication system 200 may operate in accordance with any one of a variety of wireless packet data communication systems, such as a Global System for Mobile communication (GSM) communication system, a Time Division Multiple Access (TDMA) communication system, a Frequency Division Multiple Access (FDMA) communication system, or an Orthogonal Frequency Division Multiple Access (OFDM) communication system.

BSC 222 and PCF 230 are coupled by an A8/A9 interface 226 over which they exchange A8/A9 messages. A8/A9 interface 226 that includes an A8 interface that provides a bearer path between the BSS and the PCF and an A9 signaling interface. The A8/A9 messages are assembled in each of BSC 222 and PCF 230 by their respective processor 223, 232 and pursuant to software stored in their respective memory devices 224, 234. PCF 230 and PDSN 240 are coupled by an A10/A11 interface 236 over which they exchange A10/A11 messages. The A10/A11 messages are assembled in each of PCF 230 and PDSN 240 by their respective processor 232, 242 and pursuant to software stored in their respective memory devices 234, 244.

In order to avoid billing a customer associated with MS 202 for data packets that were dropped by infrastructure 210, communication system 200 provides an accounting to a billing system 260 of a quantity of data received by BSS 220 from MS 202 and a quantity of data transmitted to MS 202 by BSS 220. FIG. 3 is a logic flow diagram 300 of the steps executed by communication system 200, and in particular by infrastructure 210, in providing an accounting to a billing system 260. Logic flow diagram 300 begins (302) when BSS 220, preferably BSC 222 or alternatively BTS 221, determines (304), preferably counts, a quantity of data, such as a number of bytes, transmitted by the BSS to MS 202 via forward link 206. BSS 220, preferably BSC 222 or alternatively BTS 221, further counts (306) a quantity of data, such as a number of bytes, received by BSS 220 from MS 202 via reverse link 208. BSS 220, preferably BSC 222, then assembles (308) an A8/A9 Usage Report parameter 228 that includes a first set of information concerning the forward link data count, the reverse link data count, or both the forward link and the reverse link data counts, and conveys (310) the assembled A8/A9 Usage Report parameter 228 to PCF 230 over A8/A9 interface 226.

In response to receiving A8/A9 Usage Report parameter 228, PCF 230 assembles (312) an A10/A11 Airlink Record 238 that includes a second set of information concerning the forward link and/or reverse link data counts received from BSS 220 and conveys (314) the assembled A10/A11 Airlink Record238 to PDSN 240 via A10/A11 interface 236. In response to receiving A10/A11 Airlink Record 238, PDSN 240 assembles (316) an modified Accounting Request message that includes a third set of information concerning the forward link and/or reverse link data counts received by the PDSN from PCF 230 and conveys (318) the modified Accounting Request message to a billing system 260 associated with ISP 250. The logic flow then ends (320).

In one embodiment of the present invention, A8/A9 Usage Report parameter 228 comprises an A9-RELEASE-A8 message that has been modified to inform of a quantity of data transmitted by BSS 220 to, and/or received by BSS 220 from, MS 202. In another embodiment of the present invention, A8/A9 Usage Report parameter 228 may comprise an A9-UPDATE-A8 message that has been modified to inform of a quantity of data transmitted by BSS 220 to, or received by BSS 220 from, MS 202. A9-RELEASE-A8 messages and A9-UPDATE-A8 messages are respectively described in detail in the TIA/EIA IS-2001 specifications, which sections are available from the Telecommunications Industry Association and is hereby incorporated by reference herein.

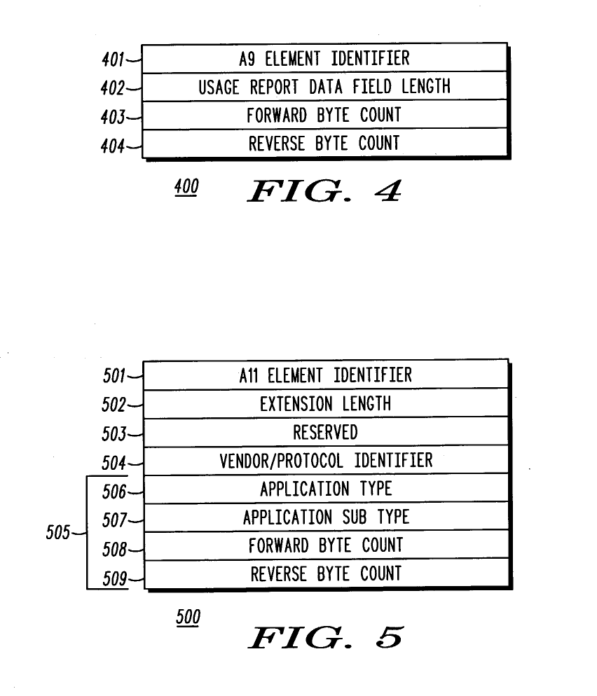

Preferably, each of the modified A9-RELEASE-A8 message and the modified A9-UPDATE-A8 message is modified to include an A8/A9 Usage Report data field that identifies the message as an A8/A9 Usage Report parameter and that informs of a quantity of data transmitted by BSS 220 to, and/or received by BSS 220 from, MS 202. FIG. 4 is a block diagram of an A8/A9 Usage Report data field 400 of a modified A9-RELEASE-A8 message or a modified A9-UPDATE-A8 message in accordance with an embodiment of the present invention. A8/A9 Usage Report data field 400 is sub-divided into multiple data fields 401-404. A first data field 401 of the multiple data fields 401-404 is an A9 Element Identifier data field that identifies the A8/A9 message as a Usage Report message. A second data field 402 of the multiple data fields 401-404 is a Usage Report Data Field Length data field that informs of a length of Usage Report data field 400. A third data field 403 of the multiple data fields 401-404 is a Forward Byte Count, or Forward Octet Count, data field that informs of a quantity of data transmitted by BSS 220 to MS 202. A fourth data field 404 of the multiple data fields 401-404 is a Reverse Byte Count, or Reverse Octet Count, data field that informs of a quantity of data transmitted by MS 202 to BSS 220.

In one embodiment of system 200, wherein MS 202 acknowledges data packets successfully received by the MS, Forward Byte Count data field 403 may includes a count only of a quantity of data transmitted by BSS 220 and acknowledged by MS 202. However, in another embodiment of system 200, Forward Byte Count data field 403 may include a count of transmitted data regardless of whether the data has been acknowledged, as would be the case in an embodiment of system 200 that does not include acknowledgements.

Preferably, A10/A11 Airlink Record 238 comprises an A11-REGISTRATION REQUEST message that has been modified to inform of a quantity of data transmitted by BSS 220 to, or received by BSS 220 from, MS 202. A11-REGISTRATION REQUEST messages are well known in the art and are described in detail in the TIA/EIA IS-2001 specifications, which specifications are available from the Telecommunications Industry Association and are hereby incorporated by reference herein. Preferably, the A11-REGISTRATION REQUEST message is modified to include a Usage Report extension that identifies the message as an A10/A11 Airlink Record and that informs of a quantity of data transmitted by BSS 220 to, and/or received by BSS 220 from, MS 202. The A11-REGISTRATION REQUEST message may be further modified to inform of the quantity of data transmitted by BSS 220 to, and/or received by BSS 220 from, MS 202 in an Airlink Record that is included in the message.

FIG. 5 is a block diagram of anew Normal Vendor/Organization Specific Extension (NVSE) 500 of an All-REGISTRATION REQUEST message in accordance with an embodiment of the present invention. NVSE 500 comprises multiple data fields 501-505. A first data field 501 of the multiple data fields 501-505 is an A11 Element Identifier data field 501 that identifies NVSE itself in the A11-REGISTRATION REQUEST message as comprising accounting information. A second data field 502 of the multiple data fields 501-505 is an extension length data field. A third data field 503 of the multiple data fields 501-505 is reserved for purposes of an operator of system 200. A fourth data field 504 of the multiple data fields 501-505 includes a 3GPP2 Vendor Identifier. A fifth data field 505 of the multiple data fields 501-505 is an A10/A11 Accounting Record that identifies the quantity of data transmitted by BSS 220 to, or received by BSS 220 from, MS 202.

Preferably, A10/A11 Accounting Record data field 505 comprises multiple data fields 506-509. A first data field 506 of the multiple data fields 506-509 is an Application Type data field that identifies the Accounting Record in the A11-REGISTRATION REQUEST message. A second data field 507 of the multiple data fields 506-509 is an Application Sub Type data field that identifies the Application Sub Type within the Application Type as a RADIUS record. A third data field 508 and a fourth data field 509 of the multiple data fields 506-509 are Application Data data fields in which PCF 230, and in particular processor 232 of the PCF, respectively embeds data concerning the Forward Byte Count, or Forward Octet Count, and/or Reverse Byte Count, or Reverse Octet Count, data that the PCF received from BSS 220 and that respectively inform of the quantity of data transmitted by BSS 220 to MS 202 and the quantity of data transmitted by MS 202 to BSS 220. PCF 230, and in particular processor 232 of the PCF, may further modify the A 11-REGISTRATION REQUEST message by embedding data corresponding to the Forward Byte Count, or Forward Octet Count, and/or Reverse Byte Count, or Reverse Octet Count, data in an Airlink Record of the A11-REGISTRATION REQUEST message.

PDSN 240 then conveys information concerning the Forward Byte Count, or Forward Octet Count, and/or Reverse Byte Count, or Reverse Octet Count, data that the PDSN received from PCF 230 in the A10/A11 Airlink Record to billing system 260, preferably to an Authentication, Authorization, and Accounting proxy (AAA) 262 in billing system 260 that then conveys billing data, via an Accounting Gateway 264, to a Billing Service 266 associated with ISP 250. Preferably, the Forward Byte Count and/or the Reverse Byte Count data is conveyed by PDSN 240 to billing system 260 in a modified Accounting Request message 246. Unlike the Accounting Request message of the prior art, modified Accounting Request message 246 is modified to include a Forward Byte Count, or Forward Octet Count, data field and/or Reverse Byte Count, or Reverse Octet Count, data field in which processor 242 of PDSN 240 embeds data corresponding to the Forward Byte Count, or Forward Octet Count, and/or Reverse Byte Count, or Reverse Octet Count, data received by the PDSN from PCF 230 in A10/A11 Airlink Record 238.

In sum, packet data communication system 200 provides accounting updates concerning data received by BSS 220 from, and/or transmitted by BSS 220 to, MS 202. BSS 220 determines at least one of a quantity of data received by the BSS from MS 202 and a quantity of data transmitted by BSS 220 to MS 102 and assembles an A8/A9 Usage Report parameter 228 that includes a first set of information concerning the determined quantity of data. In one embodiment of the present invention, the A8/A9 Usage Report parameter 228 comprises an A9-RELEASE-A8 message. In another embodiment of the present invention, the A8/A9 Usage Report parameter 228 comprises an A9-UPDATE-A8 message. BSS 220 then conveys the assembled A8/A9 Usage Report parameter 228 to PCF 230.

In response to receiving A8/A9 Usage Report parameter 228 from BSS 220, PCF 230 assembles an A10/A11 Airlink Record 238 that includes a second set of information concerning the determined quantity of data received by BSS 220 from MS 202 and/or transmitted by BSS 220 to MS 102. In one embodiment of the present invention, A10/A11 Airlink Record 238 comprises an A11-REGISTRATION REQUEST message. PCF 230 then conveys the assembled A10/A11 Airlink Record 238 to PDSN 240. In response to receiving A10/A11 Airlink Record 238 from PCF 230, PDSN 240 assembles an Accounting Request 246 that includes a third set of information concerning the determined quantity of data received by BSS 220 from MS 202 and/or transmitted by BSS 220 to MS 102. Each of the first, second, and third sets of information may be the same information or may be different but related information. PDSN 240 then conveys Accounting Request 246 to billing system 260, thereby permitting the billing system to properly bill a customer associated with MS 202 for a number of data packets actually received and/or transmitted by the MS.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for providing accounting updates in a packet data communication system comprising steps of:
determining, by a base station subsystem (BSS), at least one of quantity of data received by the BSS from a mobile station and a quantity of data transmitted by the BSS to the mobile station;
conveying, by the BSS, a first set of information concerning the determined quantity of data to a packet control function (PCF) via an A8/A9 interface;
in response to receiving the first set of information, conveying, by the PCF, a second set of information concerning the determined quantity of data to a packet data service node (PDSN) via an A10/A11 interface; and
in response to receiving the second set of information, conveying, by the PDSN, a third set of information concerning the determined quantity of data to a billing service.

2. The method of claim 1, wherein the step of determining a quantity of data transmitted by the base station subsystem (BSS) to the mobile station comprises a step of determining a quantity of data transmitted by the BSS to the mobile station and acknowledged by the mobile station.

3. The method of claim 1, wherein the step of conveying, by the base station subsystem (BSS), a first set of information concerning the determined quantity of data to a packet control function (PCF) via an A8/A9 interface comprises steps of:
assembling, by the BSS, an A8/A9 Usage Report parameter that includes a first set of information concerning the determined quantity of data; and
transmitting, by the BSS, the A8/A9 Usage Report parameter to the PCF.

4. The method of claim 1, wherein the step of conveying, by the base station subsystem (BSS), a first set of information concerning the determined quantity of data to a packet control function (PCF) via an A8/A9 interface comprises steps of:
assembling, by the BSS, an A9-RELEASE-A8 message that comprises the first set of information concerning the determined quantity of data; and
transmitting, by the BSS, the A9-RELEASE-A8 message to the PCF.

5. The method of claim 1, wherein the step of conveying, by the base station subsystem (BSS), a first set of information concerning the determined quantity of data to a packet control function (PCF) via an A8/A9 interface comprises steps of:
assembling, by the BSS, an A9-UPDATE-A8 message that comprises the first set of information concerning the determined quantity of data; and
transmitting, by the BSS, the A9-UPDATE-A8 message to the PCF.

6. The method of claim 1, wherein the step of conveying, by the packet control function (PCF), a second set of information concerning the determined quantity of data to a packet data service node (PDSN) via an A10/A11 interface comprises steps of:
assembling, by the BSS, an A10/A11 Airlink Record that comprises a second set of information concerning the determined quantity of data; and
transmitting, by the PCF, the A10/A11 Airlink Record to the PDSN.

7. The method of claim 1, wherein the step of conveying, by the packet control function (PCF), a second set of information concerning the determined quantity of data to a packet data service node (PDSN) via an A10/A11 interface comprises steps of:
assembling, by the BSS, an A11-REGISTRATION REQUEST message that comprises a second set of information concerning the determined quantity of data; and
transmitting, by the PCF, the A11-REGISTRATION REQUEST message to the PDSN.

8. The method of claim 1, wherein the step of conveying, by the packet data service node (PDSN), a third set of information concerning the determined quantity of data to a billing service comprises steps of:
assembling, by the PDSN, an Accounting Request message that comprises a third set of information concerning the determined quantity of data; and
transmitting, by the PDSN, the Accounting Request message to the billing service.

9. An apparatus for providing an accounting update for a packet data communication system comprising a base station controller (BSC) that determines at least one of quantity of data received by a base station subsystem (BSS) from a mobile station and a quantity of data transmitted by the BSS to the mobile station and assembles an A8/A9 Usage Report parameter comprising a first set of information concerning the determined quantity of data.

10. The apparatus of claim 9, wherein the base station controller further transmits the A8/A9 Usage Report parameter.

11. The apparatus of claim 10, further comprising a packet control function (PCF) that receives the A8/A9 Usage Report parameter from the base station controller (BSC) and, in response to receiving the A8/A9 Usage Report parameter, assembles an A10/A11 Airlink Record comprising a second set of information based on the first set of information.

12. The apparatus of claim 11, wherein the packet control function further transmits the A10/A11 Airlink Record.

13. The apparatus of claim 12, further comprising a packet data service node (PDSN) that receives the A10/A11 Airlink Record from the packet control function (PCF) and, in response to receiving the A10/A11 Airlink Record, assembles an Accounting Report message comprising a third set of information based on the second set of information.

14. The apparatus of claim 11, wherein the packet data service node further transmits the Accounting Report message.

15. An apparatus for providing an accounting update for a packet data communication system comprising a packet control function (PCF) that receives data concerning at least one of a quantity of data received by a base station subsystem from a mobile station and a quantity of data transmitted by the base station subsystem to a mobile station and, based on the sent and/or received data, assembles an A10/A11 Airlink Record comprising a information concerning the sent and/or received data.

16. The apparatus of claim 15, wherein the packet control function further transmits the A10/A11 Airlink Record.

17. The apparatus of claim 16, further comprising a packet data service node (PDSN) that receives the A10/A11 Airlink Record from the packet control function (PCF) and, in response to receiving the A10/A11 Airlink Record, assembles an Accounting Report message comprising information concerning the send and/or received data.

18. A machine-readable medium having stored thereon machine-executable instructions for assembling an A8/A9 message comprising at least one of a quantity of data received by a base station subsystem from a mobile station and a quantity of data transmitted by the base station subsystem to a mobile station.

19. The A machine-readable medium of claim 18, wherein the A8/A9 message comprises an A9-RELEASE-A8 message that comprises at least one of a quantity of data received by a base station subsystem from a mobile station and a quantity of data transmitted by the base station subsystem to a mobile station.

20. The machine-readable medium of claim 18, wherein the A8/A9 message comprises an A9-UPDATE-A8 message that comprises at least one of a quantity of data received by a base station subsystem from a mobile station and a quantity of data transmitted by the base station subsystem to a mobile station.

21. A machine-readable medium having stored thereon machine-executable instructions for assembling an A10/A11 message comprising at least one of a quantity of data received by a base station subsystem from a mobile station and a quantity of data transmitted by the base station subsystem to a mobile station.

22. The machine-readable medium of claim 21, wherein the A10/A11 message comprises an A11-REGISTRATION REQUEST message that comprises at least one of a quantity of data received by a base station subsystem from a mobile station and a quantity of data transmitted by the base station subsystem to a mobile station.
